(19) United States
(12) Patent Application Publication
(10) Pub. No.: US 2006/0112836 A1
(43) Pub. Date: Jun. 1, 2006

(54) Frying device

(76) Inventor: Ulrich Maurer, Wallisellen (CH)

Correspondence Address: BACHMAN & LAPOINTE, P.C., 900 CHAPEL STREET, SUITE 1201, NEW HAVEN, CT, 06510, US

(21) Appl. No.: 10/533,426

(22) PCT Filed: Oct. 30, 2003
(86) PCT No.: PCT/CH03/00707

§ 371 Date: Apr. 29, 2005

(30) Foreign Application Priority Data
Oct. 30, 2002 (CH) 1823/02

(51) Int. Cl. A47J 37/12

(52) U.S. Cl. 99/407

(57) ABSTRACT

A frying device comprises a unit for conveying food to be fried, a frying drum and a feed device which takes food from a food container, weighing and conveying it to a drum.

### BACKGROUND OF THE INVENTION

The invention relates to a deep frying appliance for the ‘floating’ frying of portions of food and luxury foodstuffs.

By ‘floating frying’ is meant the preparation of food or other luxury items (in the following referred to simply as ‘food’), characterised in that the food is cooked, ‘floating’ in hot fat, ie. appropriately cooked through for consumption. For this type of food preparation, the term “deep frying”, and for equipment for deep frying the term “deep fat frier” have also become accepted, and these are used in the following presentation of the invention. The deep frier in accordance with the invention is particularly suitable for the preparation of bulk items which are prepared in the form of equally sized strips.

A bulk item of the type described often intended for consumption is potatoes which are prepared for consumption by deep frying. Such bulk items are generally known under the term “chip portions.”

A device for the production of chip portions is established which produces the latter from a raw or pre-cooked bulk material automatically. The established device here essentially comprises a storage container for uncooked chips and a deep frying drum, whereby the storage container is connected to the frying drum by means of a pipe connection.

A scooping device operating in the storage container forms a pile of the pre-determined quantity and feeds this into the pipe which conveys the bulk into the deep frying drum. In the deep frying drum, the bulk is cooked through in hot oil, and then carried out of the deep frying drum.

In addition, a turning element is provided in the deep frying drum, and said turning element comprises radially projecting rakes around its circumference, positioned at equal distances around said circumference, which convey the bulk material through the hot frying fat for cooking, and then carry it out of the device.

The scooping device is in the form of a scooping pipe with a rectangular cross-section which passes through the storage container containing, for example, raw or pre-cooked strips of potato (frying material) in a vertical direction, and extracts portions. On its upper open end, the scooping pipe has two pivoting flaps which in the direction going into the scooping pipe are at an angle to one another such that the latter is closed, and in this closed position, a surface is formed where a portion of frying material can be deposited. For the portion-wise filling of the deep-frying drum, the scooping pipe is lowered with closed flaps into the storage container, and then conveyed through the frying material with closed flaps, by means of which a portion is deposited on the flaps. In the upper elevated position, the flaps open, the frying material falls into the scooping pipe, from where it is conveyed into the pipe via a discharge opening which connects the storage container to the frying drum. This technique of portion-wise filling has been proven to be effective with regard to its mechanical features and also with regard to frying material in small pieces. With regard to the individual pieces of frying material, for example individual strips of potato, if the pieces are larger (cross-section, length), the described technique is flawed with the disadvantage that the scooped portions have greatly fluctuating values with regard to quantity and weight, which with the technique described can not be adjusted to the same or comparable values.

It is an object of the invention to create a storage container with a scooping device (in the following referred to generally as “feed device”) which supplies subsequent portions of frying material which are of the same weight and volume, and for a storage container with a feed device

### SUMMARY OF THE INVENTION

The foregoing object is achieved by way of the present invention wherein a Deep frying appliance for the ‘floating’ frying of food portions comprises a deep frying drum and a feed device, which are connected to one another for the conveyance of the food portions by means of a feed pipe, the feed device has a housing with a tubular, stationary storage container accommodated in the housing, a rotatable feed wheel working in conjunction with the storage container at one end thereof to form an annular gap with the storage container, the housing with the feed wheel therein defines an annular space in which pushing elements of the feed wheel pass over a discharge opening in the floor of the housing, rotatably movable by means of a shaft, whereby the duration of the rotation is determined by scales located in the feed pipe between the feed device and the deep frying drum.

### BRIEF DESCRIPTION OF THE DRAWINGS

Further advantages, features and details of the invention are given in the following description of a preferred embodiment, given as an example, and the drawings:

FIG. 1 shows a schematic representation of a deep frying appliance with a feed device, shown in section, designed in accordance with the invention

FIG. 2 shows on overhead view of the pushing wheel accommodated in the feed device in accordance with FIG. 1.

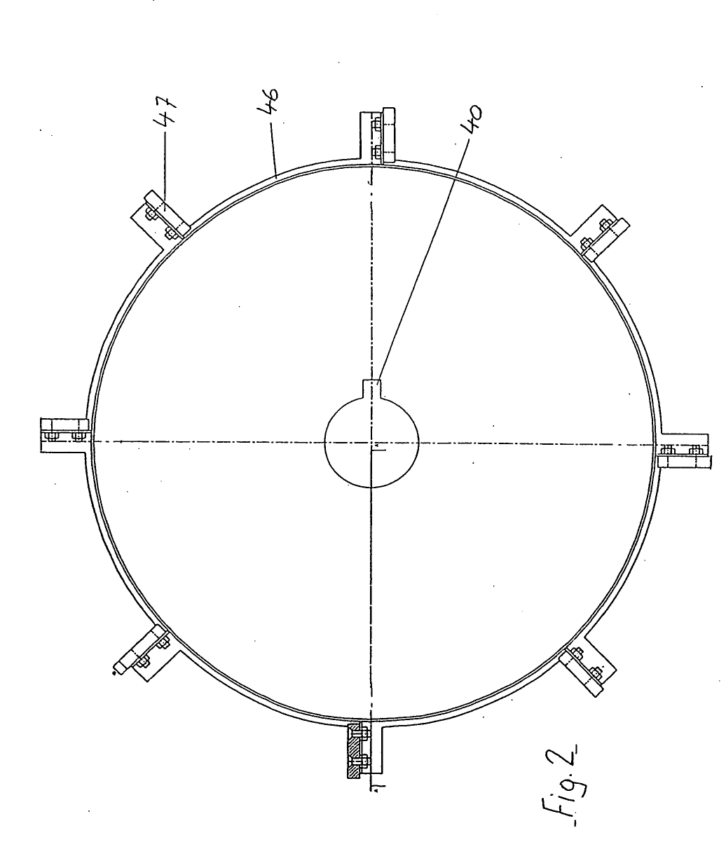

### DETAILED DESCRIPTION

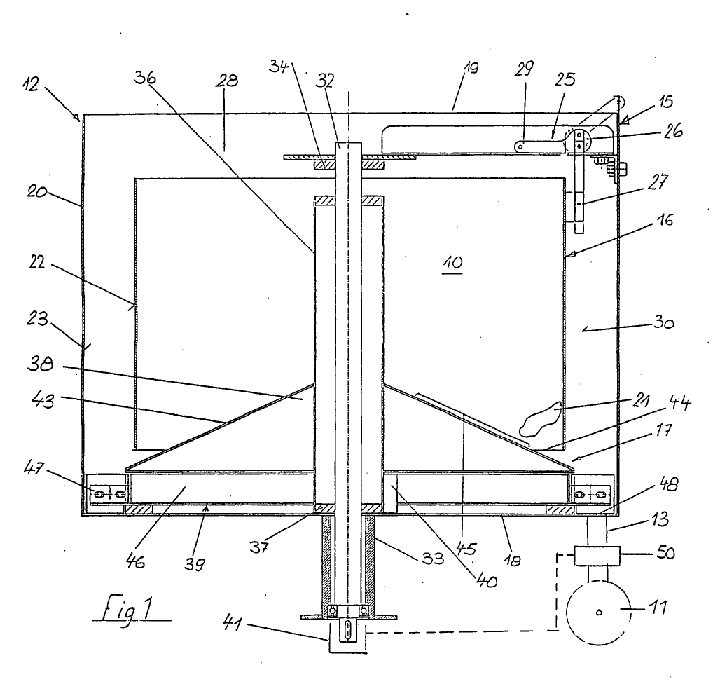

FIG. 1 shows an appliance for the ‘floating’ frying of portions of food and luxury foodstuffs in the form of bulk goods, for example potatoes prepared as loose strips, referred to as a deep frying appliance 10 for short. The deep frying appliance 10 comprises a deep frying drum 11 and a feed device 12 which are connected to one another by means of a feed pipe 13, ie. the feed pipe 13 conveys the portions issued by the feed device 12 to the deep frying drum 11. The deep frying drum 11 comprises a housing containing liquid, heated cooking fat, wherein a turning device rotates, conveying the portions through the cooking fat, said portions then being carried out of the housing.

The feed device 12 comprises a housing 15, wherein a storage container 16 and a rotatable feed wheel 17 are accommodated. On one side the housing is securely sealed by a floor 18, whereas the side 19 opposite the floor 18 is open and can be closed by means of a removable lid (not shown). The housing 15, ie. the floor 18 and the circumference wall 20 of the housing 15 can be designed in such a way that cooling devices (not shown), which keep the frying material 21 cool, can be accommodated therein. In this instance, the side 19 is closed by means of an insulated cover. The storage container 16 is located in the housing 15 concentrically to the housing 15. The storage container 16 is a pipe element, open on both sides, which extends axially to a lesser extent than the inner space of the housing 15. On its end facing the side 19 of the housing 15 the outer surface 22 of the storage container 16 is in contact with the inner surface 23 of the housing 15. (The inner space 28 of the housing 15 is cylindrical in form). In addition, around the circumference of the inner surface 23, preferably three excentrics 25, spaced equally apart from one another, are provided, which are connected at the one end to the inner surface 23 of the housing 15 by means of an excentric disc 26, and at the other end to the outer surface 22 of the supply container 16 by means of a rod 27. The storage container is therefore suspended from the rods 27, free and concentric, in the inner space 28 of the housing 15. The purpose of the excentrics 25 is to provide a storage container 16 in the inner space 28 of the housing 15 in such a form that it can be moved axially and be fixed to the floor 18 or feed wheel 17, preferably in two axial movement positions. In FIG. 1 the excentric 25 is shown in two positions, and dependent upon how the excentricity of the excentric disc 26 is disposed, the storage container 16 in the housing 15 can be lifted to the side 19 or lowered in the direction of the floor 18 by manipulating the excentric lever 29. The storage container 16 has an outer diameter which is smaller than the inner diameter of the inner space 28, by means of which an annular space 30 is formed between the housing 15 and the storage container 16.

In a perpendicular direction, axially and concentrically, a rotatable shaft 32 passes through the storage container 16, one end of said shaft being linked to the floor 18, (and passing through said floor), by means of a bearing bush 33, and the other end being located in a support 34 which in turn is linked to the inner surface 23 of the housing 15. The feed wheel 17 is engaged with this shaft 32. The feed wheel 17 comprises a sleeve 36 which encloses the shaft 32, and has a diameter greater than the shaft 32, and which runs in the same direction as the shaft 32, from the floor 18 to near to the support 34. The sleeve 36 engages with the shaft 32 by means of perforated discs 37. The feed wheel 17 is linked to the sleeve 36, said feed wheel consisting of a feed cone 38 and a pushing wheel 39, whereby the feed cone 38 is linked to the sleeve 36, and the pushing wheel 39 is engaged with the sleeve 36 by means of catches 40. By turning the shaft 32, driven by the electric motor 41, the sleeve 36, the pushing wheel 39 and the feed cone 38 turn with the shaft 32. The feed cone 38 is a straight circular cone through which the sleeve 36 passes, the base circle of which has a slightly greater diameter (approx. 5 to 10%) than that of the tubular storage container 16. FIG. 1 shows the storage container 16 in elevated position. Between the cladding surface 43 of the feed cone 35 and the open base of the storage container 16, an annular gap 44 is thus created—limited by the cladding surface 43 of the feed cone 38 and the outer surface 22 of the storage container 16—through which frying material 21 passes out of the storage container 16 into the annular space 30. If the storage container 16 is lowered by adjusting the excentrics 25, the circumference wall of the storage container 16 then rests on the cladding surface 43 of the feed cone 38 which extends into the storage container 16, and the annular gap 44 is closed. The annular gap 44 is closed when, with the shaft 32 remaining still, the storage container 16 is filled with frying material 21, so as to prevent the frying material 21 from sliding into the annular space 30 during the filling process. On the cladding surface 43 of the feed cone 38, ribs 45, and preferably three ribs 45, which run radially and stick out from the cladding surface, can be provided on the cladding surface 38, the purpose of which is to loosen frying material 21 lying on the cladding surface 43 while the feed wheel 17 is turning. The pushing wheel 39 is located between the floor 18 and the base of the feed cone 38, revolving with the feed cone 38, separated from the floor 18. The pushing wheel 39 has a cylindrical wheel section 46, open on one side towards the base of the feed cone 38, from the circumference surface of which pushing elements 47 project radially, spaced evenly over the surface of the circumference, and engaging in the annular space 30. The diameter of the cylindrical wheel section 46 corresponds to that of the base of the feed cone 38 so that frying material 21 is conveyed from the cladding surface 43 between the pushing elements 47, and in this way the spaces between the pushing elements 47 are kept filled. The pushing elements 47 move the frying material 21 in the annular space 30 until it passes over a discharge opening 48 to which the feed pipe 13 is connected, and into which the frying material 21 falls in a pre-determined quantity, ie. in a portion. The portioning of frying material 21 is achieved by means of scales 50 which, by means of the electric motor 41, determine the duration of the rotation of the feed wheel 17 and so the quantity of frying material 21 discharged from the discharge opening 48. If the deep frying drum 11 is to be loaded with frying material 21, the electric motor 41 starts up and turns the feed wheel 17, discharging frying material 21 from the discharge opening 48 and passing over the scales 50 integrated into the feed pipe 13, until the scales 50 have weighed the pre-set portion weight and have sent the motor 50 a signal to cease rotation, by means of which the discharge of frying material from the discharge opening 48 comes to a halt.

1-9. (canceled)

10. Deep frying appliance for the ‘floating’ frying of food portions comprises a deep frying drum and a feed device, which are connected to one another for the conveyance of the food portions by means of a feed pipe, the feed device 12 has a housing 15 with a tubular, stationary storage container 16 accommodated in the housing 15, a rotatable feed wheel 17 working in conjunction with the storage container 16 at one end thereof to form an annular gap 44 with the storage container 16, the housing 15 with the feed wheel 17 therein defines an annular space 30 in which pushing elements 47 of the feed wheel 17 pass over a discharge opening 48 in the floor 18 of the housing 15, rotatably movable by means of a shaft 32, whereby the duration of the rotation is determined by scales 50 located in the feed pipe 13 between the feed device 12 and the deep frying drum 11.

11. Appliance in accordance with claim 10, wherein the scales 50 are connected to an electric motor 42 which drives the feed wheel 17 by means of a shaft, and give signals.

12. Appliance in accordance with claim 10, wherein the storage container 16 in the housing 15 can be adjusted axially to the housing by adjusting means.

13. Appliance in accordance with claim 12, wherein the adjusting means for adjusting the storage container comprises at least three excentrics positioned equidistantly around the storage container 16, connected to the storage container 16 and the housing 15.

14. Appliance in accordance with claim 10, wherein the housing 15 includes cooling devices.

15. Appliance in accordance with claim 12, wherein the feed wheel 17 has a feed cone 38 and a pushing wheel 39 connected to the feed cone 38, with pushing elements 47 projecting radially from the pushing wheel 39.

16. Appliance in accordance with claim 15, wherein the feed cone 38, leaves an annular gap 44 in the storage container 16 between a cladding surface 43 of the feed cone 38 and a circumference wall 22 of the storage container 16.

17. Appliance in accordance with claim 16, wherein a front side of the circumference wall 22 of the storage container 16 can be brought into contact with the cladding surface 43 of the feed cone 38 by the adjusting means.

18. Appliance in accordance with claim 16, wherein the cladding surface 43 has at least 3 ribs 45 which extend radially, and spaced equally from one another.
